(19) United States
(12) Patent Application Publication
(10) Pub. No.: US 2020/0161856 A1
(43) Pub. Date: May 21, 2020

(54) POWER DISTRIBUTION SYSTEMS FOR AC AND DC POWER

(71) Applicant: SIGNIFY HOLDING B.V., EINDHOVEN (NL)

(72) Inventors: Priya Ranjan MISHRA, EINDHOVEN (NL); Matthias WENDT, EINDHOVEN (NL); Goutam MAJI, EINDHOVEN (NL)

(21) Appl. No.: 16/634,294

(22) PCT Filed: Jul. 23, 2018
(86) PCT No.: PCT/EP2018/069877

§ 371 Date: Jan. 27, 2020

(30) Foreign Application Priority Data
Jul. 28, 2017 (IN) 201741026888
Nov. 2, 2017 (EP) 17199748.9

(51) Int. Cl. H02J 1/14; H02J 3/32; H02J 5/00

(52) U.S. Cl. CPC H02J 1/14; H02J 5/00; H02J 3/32

(57) ABSTRACT

A power distribution system receives an AC power supply (10) and supplies power to a plurality of electrical loads (A1-A4, . . . , J1-J4) over a distribution network. The system has a plurality of DC power supplies (13) for use when the AC power supply is unavailable. A system controller (14) controls the plurality of DC power supplies to supply a time-averaged DC current which is equal to or smaller than an RMS current rating of the power lines (W1, W2) of the distribution network.

### FIELD OF THE INVENTION

This invention relates to power distributions systems, in particular for distributing both AC and DC power to loads. The AC power for example is for mains driving of the loads, and the DC power is for a backup mode. The DC power is derived from local energy storage devices, such as local batteries.

### BACKGROUND OF THE INVENTION

One example of a networked system which uses mains power and DC power is a lighting network, have a backup mode for providing lighting, or at least emergency lighting, during a mains failure. For this purpose, the system has a battery backup supply. US20160181807A1 discloses that on top of AC power supply, DC power supplies can be activated during high peak power demand.

During a failure of the mains, networked luminaires with integrated batteries are isolated from the mains AC grid and a local DC grid is formed. An example of a system which operates in this way is disclosed in WO2013/182927.

Since the DC grid voltage is approximately one tenth of the AC mains grid signal, the current flowing through the same infrastructure will be ten times the AC (RMS) current to achieve the same power delivery. This may lead to a temperature rise above recommended levels in certain sections of the power distribution line, which may lead to deterioration of cable insulation and may further lead to safety hazards, and failure in the DC/AC mode.

In networked battery-integrated luminaires, stored energy is shared among different luminaires. The current flow through the cables is dependent on the state of charge (SoC) of the batteries and the lamp load of individual batteries. This means that the desired current flows in part of the network may exceed rated current levels. This problem will be amplified further when the storage capacity is designed with a low diversity factor (DF), which means the total storage is below the total peak energy demand requirement. This is desirable to reduce the cost of storage. However, in turn a few batteries have to supply power to a lot of luminaires and their respective currents superimpose and lead to overcurrent on the power distribution line.

The problem can be solved by early prediction of the load pattern but this needs complicated sharing of current from two sources i.e. from the internal battery and external power from the grid. In such cases, a normal LED driver designed for a battery-integrated luminaire cannot be used.

Therefore, there is a need for a solution to control the current flow in a power distribution network such that in the various different sections of the distribution lines, the current remains below the relevant rated limit while also meeting the distributed load demand in real time.

### SUMMARY OF THE INVENTION

It is a concept of the invention to control the power supply to and from electrical loads in a power distribution network so that the current, averaged by time, flowing in power lines of the network remains below a rated current level. More specifically, the currents to all of the electrical loads are controlled on a time sharing basis, instead of providing current from every DC power supply to every electrical load all the time. Thus the DC current over the distribution network can be split in a time-division manner, and the time-average current over the distribution network is reduced. This avoids overheating of cables and hence avoids the risk of cable damage and also reduces the risk of creating a fire hazard.

The invention is defined by the claims.

According to examples in accordance with an aspect of the invention, there is provided a power distribution system comprising:

an AC input for accessing an AC power supply;

a plurality of electrical loads;

a distribution network adapted to conduct AC current from said AC power supply to the plurality of electrical loads, wherein said distribution network has an RMS current rating;

a plurality of DC power supplies for supplying the electrical loads by supplying DC current using the same distribution network to the electrical loads when the AC power supply is unavailable; and

a system controller, which is adapted to control the plurality of DC power supplies to supply a time-averaged DC current which is equal to or smaller than said RMS current rating.

This power distribution system enables distribution of AC current between loads, but also enables distribution of DC current from DC power supplies between the loads. This is for example of interest for a network of devices which includes backup DC power, either centrally located or within the individual loads. This mitigates a need of extra wiring. The AC current is typically provided at a much higher voltage (e.g. mains voltage) than the DC current (e.g. a battery voltage) so that for an equivalent power transfer, higher currents are required during the DC power transfer. These currents may exceed rated currents of one or more cables of the distribution network (there may be different cables within the network with different ratings), and the invention enables this overload to be avoided by actively controlling at least the DC power supplies in supplying the DC current on a time sharing basis. Here the limitation of “when the AC power supply is unavailable” includes both situations of a passive mains failure and an active isolation from the mains at peak hours or in response to a demand request.

The system mitigates the risk of insulation failure of the network distribution cables due to overcurrent during a DC power sharing mode, or during a feed mode from both distributed and centralized batteries.

In an embodiment, at least some of said DC power supplies may be adapted to supply the DC current in a time divided manner for maintaining an instantaneous or average DC current in the distribution network below the RMS current rating.

By sharing current supplying times in an intelligent manner, currents flowing in the network can be controlled.

In another embodiment, at least some of said electrical loads may be adapted to receive a DC current in a time divided manner for maintaining an instantaneous or average DC current in the distribution network below the RMS current rating.

Similarly, by sharing current demand times in the loads in an intelligent manner, currents flowing in the network can be controlled.

A DC energy storage device may be associated with each of the electrical loads, and wherein the controller is further adapted to:

obtain the length of a duration for which said AC power supply is unavailable;

obtain charging state information for the DC energy storage device in each of the electrical loads;

determine at least some of the electrical loads which are to supply the DC current from their respective DC energy storage device and at least some other of the electrical loads which are to receive the DC current; and

configure, accordingly, the DC current to be exchanged between at least some of said plurality of DC power supplies and at least some of the loads.

Here, a gap with no DC current, between the time divided DC currents, in an electrical load, is filled at least by the DC energy storage in the electrical load. The electrical load with a DC energy storage in a high state of charge needs less or no DC current, or can operate as a DC power supply; while the electrical load with a DC energy storage in a low state of charge needs more DC current. By scheduling the different DC currents in a time division manner with a constraint of not exceeding the RMS current rating, different electrical loads can be supplied as sufficiently as possible. The DC currents in the network in this way take account of charging state information, such as the state of charge of local batteries. The currents exchanged will result in different combined current levels at different parts of the network, and in different cables of the network. These cables may have different current ratings, and the configuration can take account of the currents (and hence local heating) in different parts of the network.

In a further embodiment, the controller may be further adapted to control a drive setting of the electrical loads that are to supply the DC current and/or a drive setting of the electrical loads that are to receive the DC current, thereby to control the power consumption thereof in order to control the DC current.

The drive setting for example may be a dimming level for an electrical load in the form of a luminaire. At the electrical load, a low drive setting causes more power in the DC energy storage device for other electrical loads. Other electrical loads may have different drive settings so that the current demand can be regulated also. By tuning the drive settings, the delivery of the DC current can be extended in order to better cover the duration for which said AC power supply is unavailable.

In addition or alternative to the above embodiment wherein the individual electrical load is associated with a local DC energy storage device, the plurality of DC power supplies may comprise a central DC energy storage device and at least some of said plurality of electrical loads are adapted to receive the DC current in a time divided manner.

In this case, there are one or more central storage devices which are placed for example in a central power cabinet and distribute current to the electrical loads. The loads then receive the current in time divided manner to prevent current overload in the cables of the network.

In a further embodiment, the system may further comprise a grid feed inverter adapted to convert the DC current into AC power and feed it to the AC power supply, wherein at least some of said plurality of electrical loads are adapted to supply the DC current to the grid feed inverter in a time divided manner.

The DC current may thus be used for providing excess power (for example solar generated energy) back to the electrical grid. This is typically an additional option which may be performed when the AC supply is available or not available, depending on the overall charge status of the DC power supplies and demand status of the electrical loads. Alternatively the local energy storage may be used for time shifting to draw power from the grid at a low price point and use the power or return power to the grid at a higher price point. It can be understood that if all the local energy storages release power simultaneously for a long duration, the distribution line may face a risk. Thus, this embodiment proposes that the local energy storages supply the grid feeding power in a time divided manner.

At least some of said DC power supplies may be adapted to supply the DC current simultaneously for a first duration such that the instantaneous DC current on the distribution network is above the RMS current rating in the first duration, and the at least some of said DC power supplies may be adapted to stop supplying the DC current or supply a DC current below the RMS current rating for a second duration after first duration.

The system may maintain the current at any time below the rated RMS current. However, in this example, the current is instead allowed to exceed the rated current for short time periods. This defines a burst mode of operation. The average current is still maintained below the rated current.

The RMS current rating may be variable as a function of ambient temperature and the controller is further adapted to determine the RMS current rating based on an ambient temperature.

The problem with exceeding a rated current is typically local cable heating. Thus, the current at which local heating becomes an issue is in fact dependent on the ambient temperature. The ambient temperature influences the heat dissipation ability of the wire and hence influences the temperature reached by the wire. If the ambient temperature is high, the heat generated by a certain current limit cannot dissipate well and heats the wire. Thus, by monitoring ambient temperature, the actual current limits can be assessed more accurately.

In a further embodiment, a temperature estimation unit may be provided which comprises an ambient temperature sensor and a processor to estimate the temperature of the distribution network according to the instantaneous DC current levels within the distribution network.

The local temperature may not need to be measured directly, but can be estimated based at least on current levels.

The system may thus further comprise:

a temperature sensor thermally coupled to the distribution network and adapted to sense a temperature of the distribution network or a temperature estimation unit for estimating the temperature of the distribution network; and

wherein the controller is further adapted to control the DC current according to the temperature of the distribution network.

This temperature may relate to the temperate at the distribution network or even at local parts of the distribution network, rather than a general ambient temperature. This enables more accurate current control.

The system controller may be adapted to select at least two pairs of a DC power supply and an electrical load, wherein portions of the distribution network that connect the at least two pairs do not overlap and the two pairs exchange the DC current simultaneously such that the DC currents in each pair are essentially isolated. Thus, different parts of a network may be isolated from each other and can conduct a respective DC current simultaneously.

The invention also provides a lighting system, comprising:

an arrangement of luminaires; and

a power distribution system as defined above, wherein each luminaire is an electrical load of the power distribution system, and the system controller comprises a light management system.

Examples in accordance with another aspect of the invention provide a power distribution method comprising:

accessing an AC power supply;

when the AC power supply is available:
conducting AC current from said AC power supply to a plurality of electrical loads, using a distribution network which has an RMS current rating; and

when the AC power supply is not available:
supplying the electrical loads using a plurality of DC power supplies to conduct DC current using the same distribution network to the electrical loads, and controlling the plurality of DC power supplies to supply a time-averaged DC current which is equal to or smaller than said RMS current rating.

The method may comprise:

supplying the DC current from the DC power supplies in a time divided manner for maintaining an instantaneous or average DC current in the distribution network below the RMS current rating; and/or

receiving a DC current at the electrical loads in a time divided manner for maintaining an instantaneous or average DC current in the distribution network below the RMS current rating.

The invention may be implemented at least in part in software.

Another aspect of the invention proposes a solution that overcomes the RMS current limit of the cable, in case that a peak current demand of electrical loads exceeds the RMS current limit. More specifically, it is provided

a power distribution system comprising:

an input to a grid power supply;

a plurality of electrical loads, wherein each electrical load is with a local DC power supply;

a distribution network adapted to conduct grid current from said grid power supply to the plurality of electrical loads, wherein said distribution network has an RMS current rating;

a system controller, adapted to control at least some of electrical loads to retrieve power from the local DC power supply according to a power requirement of the electrical loads, such that the grid current from said grid power supply does not exceed the RMS current rating.

In this aspect, the power from the local DC power supply reduces the current requirement from the grid power supply to ensure it is below the current rating. Thus the electrical loads can support applications higher than what the distribution network can provide. This improves the performance/capacity of the system without renovating the distribution network, and is very convenient/low cost.

This aspect is useful for applications with a transient high power requirement, like in a short but strong light pulse in the light show at stadium, stage, etc. At the normal or low power requirement instant, the DC power supplies can be charged for the next transient high power requirement.

The system controller is further adapted to adjust the output power of the electrical loads according to the energy left in the DC power supply. This means if both the distribution network and the DC power supply can not support the power requirement of the electrical load, the output power of the electrical load can be reduced. In the application of lighting, reducing the output power is implemented by dimming down the lighting device. Options may be based on soft, contrast, colour balance etc. of lighting effects in case the electrical loads are lighting device.

Even further, the electrical loads can be prioritized as different groups, and the system controller is adapted to satisfy the power requirement of electrical loads in high priority group and adjust the output power of electrical loads in low priority group. The priority can be set according to the layout of the electrical loads such that a high priority group can form a main/essential topology of the layout while the low priority ground can add up to the main/essential topology and complete the whole layout.

These and other aspects of the invention will be apparent from and elucidated with reference to the embodiment(s) described hereinafter.

### BRIEF DESCRIPTION OF THE DRAWINGS

Examples of the invention will now be described in detail with reference to the accompanying drawings, in which:

FIG. 1 shows a set of luminaires each associated with a local storage element;

FIG. 2 shows an operating mode in which the AC supply is disconnected;

FIG. 3 shows an example of currents flowing in different section of cables for a diversity factor of 0.9;

FIG. 4 shows an example of currents flowing in different section of cables for a diversity factor of 0.8;

FIG. 5 shows a control scheme in accordance with an example of the invention for a diversity factor of 0.8;

FIG. 6 shows a situation where more luminaires are demanding current than can be handled by the cable capacity and through temperature profiling it is handled;

FIG. 7 shows a situation where more luminaires are demanding current than can be handled by the cable capacity and is managed by dimming profile;

FIG. 8 shows that the lighting network may connect to the AC mains supply via a grid feed inverter;

FIG. 9 shows that there may be a centralized battery which connects to the wiring of the power distribution network; and

FIG. 10 shows a power distribution method.

### DETAILED DESCRIPTION OF THE EMBODIMENTS

The invention provides a power distribution system which receives an AC power supply and supplies power to a plurality of electrical loads over a distribution network. The system has a plurality of DC power supplies for use when the AC power supply is unavailable. A system controller controls the plurality of DC power supplies to supply a time-averaged DC current which is equal to or smaller than an RMS current rating of the power lines of the distribution network.

The below description first describes the embodiments of the invention wherein the electrical loads are battery-integrated luminaires and some of them are used as DC supplies while some others receive the DC power. During failure or active demand request of a mains power, battery-integrated networked luminaires are isolated from the mains (or other AC grid) and a local DC grid is formed. In a battery-integrated networked luminaire, power exchange happens between luminaires whose battery capacity is nearing to its end or whose battery is not being utilized either due to non-use or lower use e.g. dimming etc.

In general, the DC distribution lines formed will have a higher current flowing than the rated current in an AC network in providing the same power, since the DC supply voltage is often lower than the AC voltage. However in the context of the application, the AC network is re-used as DC distribution line.

The invention is based on the recognition that, in the event of multiple requests for current simultaneously, monitoring and management is needed to keep the temperature rise of the distribution lines within limits. The currents in distribution cables above a rated limit results in a temperature rise and may lead to insulation degradation and eventually breakdown. This may also result in fire and shock hazards.

The maximum current which is safe to pass along a cooler section of the distribution network may be much higher than along a hotter one. Therefore, in specific sections for specific time period, a larger current than the nominal rated current may be tolerated to meet important and critical load.

The problem is more likely to arise when a DC system is designed with a lower diversity factor (DF) whereby the total storage is less than total peak energy demand requirement. With a decrease in DF the management becomes more critical.

According to the invention, a central controller e.g. of a light management system LMS, is used to map the requirement of energy needs of different luminaires in the network. Based on the mapping, each luminaire is instructed to control their input or output current (or power) to the DC grid to ensure that the current in different sections of the distribution network is within rated limits.

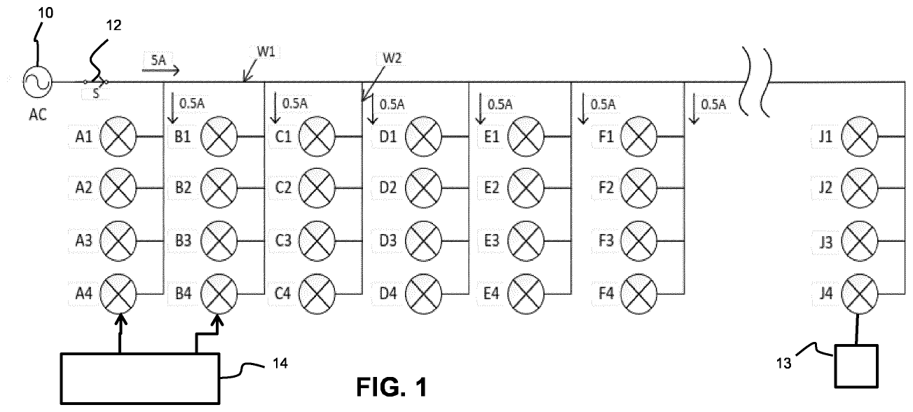

FIG. 1 shows a set of luminaires (arranged in groups A to J). Each luminaire in the group is numbered 1 to 4, and each luminaire comprises one or more lighting elements such as LED arrangements. The group may be a floor or room of a building for example. Each luminaire is for example associated with a local storage element, e.g. a battery, and there is a battery charge controller as part of each luminaire.

The set of luminaires is supplied by an AC power supply 10 through an isolation switch 12. FIG. 1 shows a system with a set of 10 groups of luminaires A to J, although only 6 (A to F and J) are shown.

FIG. 1 shows the configuration when the luminaires are all powered through the AC grid and operate in a normal operation mode. The luminaires are connected through multiple branch cables W2 to a main cable W1. By way of example, the rating (which is the RMS AC current rating or the DC current rating) is 10 A for the main cable W1 and 2 A for the branch cables W2.

Each luminaire has a local battery 13 (shown only for luminaire J4 for simplicity).

In FIG. 1, the main cable carries a maximum current of 5 A at the power source end, and each group of luminaires draws 0.5 A.

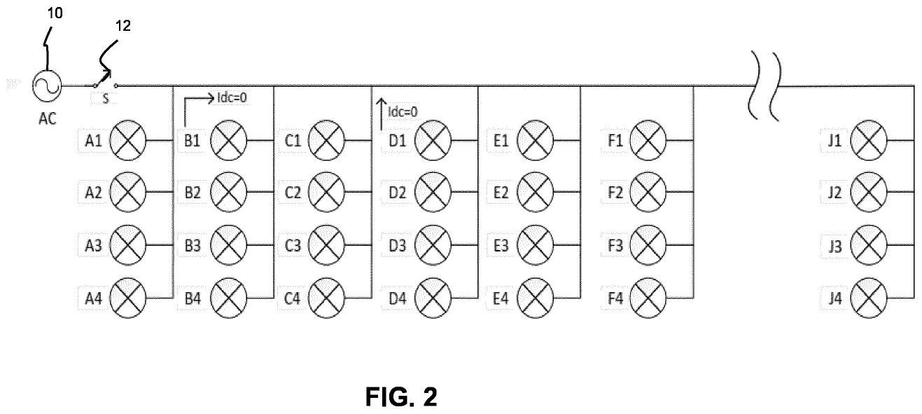

FIG. 2 shows an operating mode in which the AC supply 10 is disconnected by the switch 12 and the luminaires form a DC grid. In this case, the diversity factor DF>1, meaning the local DC energy storage device can satisfy the power need of the respective/associated luminaire, so there is no need for any current flow from one luminaire to another luminaire. The storage capacity of each luminaire is designed to meet maximum possible demand side management (DSM) request. However, this ideal but costly proposition results inefficient use of storage capacity.

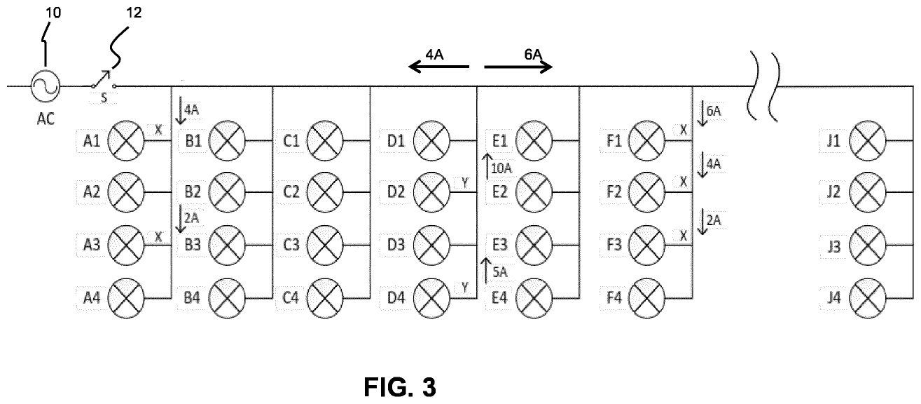

FIG. 3 shows an example of currents flowing in different section of cables for a diversity factor of 0.9. The currents flowing in some sections of the distribution network show the currents which exceeds the 2 A rated branch current.

Luminaires which are demanding external current are marked with an “X”. They are all assumed to demand a 2 A current flow so as to illuminate directly from this input current. Luminaires which have energy storage which is able to meet the additional demand are marked with a “Y”. They are assumed to be able to deliver a 5 A current flow.

As can be seen the branch current is 10 A in one D branch of the branches as there are two luminaires delivering 5 A. This 10 A current already reaches the above mentioned rating of 10 A of the wire and exceeds the above mentioned rating of 2 A.

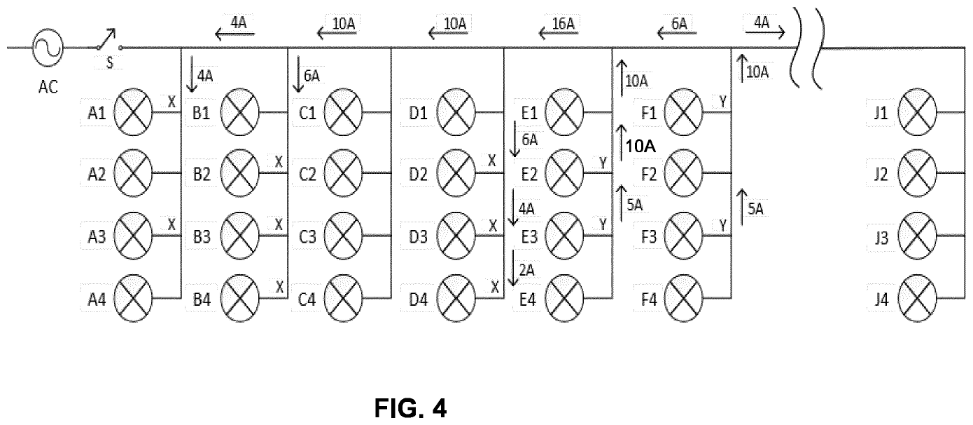

FIG. 4 shows an example of currents flowing in different section of cables for a diversity factor of 0.8. The currents flowing in some sections of the distribution network again show currents which exceed the rated current.

Luminaires which are demanding external current are again marked with an “X”. They are all assumed to demand a 2 A current flow so as to illuminate directly from this input current. Luminaires which have energy storage which is able to meet the demand are marked with a “Y”. They are assumed to be able to deliver a 5 A current flow.

As can be seen, the branch current exceeds the 2 A rating in many of the branches and the main branch current rating is also exceeded where there is one section with a 16 A current flow.

This problem is addressed by the invention.

The invention is based on the recognition that due to changes in occupancy, battery SoC etc., the energy needs of various luminaires within a network will change dynamically, so there will be a need to change the power distribution mapping accordingly. Since the current in the network distribution lines is varying all the time, the maximum allowed current will also vary due to different temperature rises of cables in different section. A more sophisticated load capability management is provided so that the whole power transfer capacity of the distribution lines can be fully utilized during the DC grid formation after transition from an AC grid supply. In addition, for lower diversity factor, more intelligence capability and more frequent mapping are provided.

The invention makes use of a system controller which controls the plurality of DC power supplies (batteries) to supply a time-averaged DC current which is equal to or smaller than the RMS current rating in the various lines of the power distribution network.

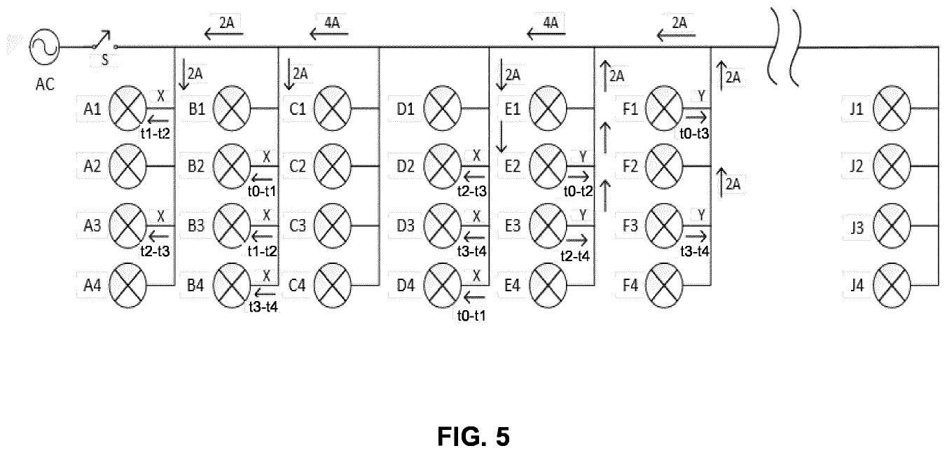

FIG. 5 shows a control scheme for a diversity factor of 0.8.

The timing of current supply to the DC grid or drawing of current from the DC grid is divided into four time periods with timing instants t0 to t4 (i.e. time periods 0 to 1, 1 to 2, 2 to 3 and 3 to 4).

The exchange of energy between luminaires is controlled such that the current flowing in different sections is within rated limits. Exchange of energy between different combinations of luminaires happens in different time slots.

Luminaires which are demanding external current are again marked with an “X”. They are all assumed to demand a 2 A current flow to illuminate but the current flow is no longer continuous, and their local DC energy storages are used to fill the gap of the discontinuous current supply. Luminaires which have energy storage which is able to meet the demand are again marked with a “Y”. They are assumed limited to deliver a 2 A current flow to meet the rated current of the branch wires. FIG. 5 shows the time slots when the currents are supplied or drawn. Table 1 illustrate the current in different branch at different time slots.

TABLE 1

Time

| Branch | t0-t1 | t1-t2 | t2-t3 | t3-t4 |
|---|---|---|---|---|
| A | | A1: X | A3: X | |
| B | B2: X | B3: X | | B4 :X |
| C | | | | |
| D | D4: X | | D2: X | D3: X |
| E | E2: Y | E2: Y | E3: Y | E3: Y |
| F | F1: Y | F1: Y | F1: Y | F3: Y |
| Overall system | 2X/2Y | 2X/2Y | 2X/2Y | 2X/2Y |

From the above map it can be seen that the current in each distribution branch is within limits i.e. 2 A in different time slots.

This time sharing will be appropriate if the required power transfer across the network can still be achieved so that the emergency power supply remains effective for the duration of the mains isolation. This may or may not be possible depending on the particular circumstances.

In any branch, only one luminaire is drawing 2 A or delivering 2 A at any time. An alternative is to lower the current so that multiple currents may flow while still meeting the rated current. The core concept is to take account of the current rating in a dynamic way to prevent rated current levels being exceeded.

The controller can additionally take account of temperature profiling.

In this case, the controller can allow the current level to be above the nominal rated current for a specific period while still maintaining the average current below the limit.

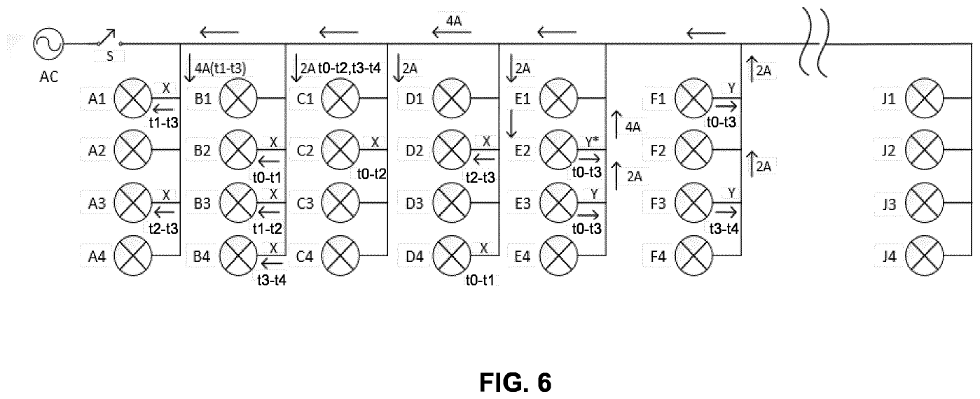

For example, in FIG. 6 luminaire A1 may be kept drawing current beyond time t2 by an additional amount Δt such as until t3 and additional luminaire C2 also demands power from t0 to t2. In such cases, the Y labeled luminaire has to supply power beyond the rated capacity i.e. at least 3 A each from E and F branches or 4 A, 2 A from the E and F branches respectively (as is shown in FIG. 6). In addition in branch A, current flows above rated capacity during t2 and t3. The above example can allow higher current in different sections while the temperature rise of the cable can be reduced in that additional period Δt i.e. t3 to t4. Similar to Table 1, Table 2 illustrates the current in different branches at different time slots. One can observe that in certain time slots, the current in one or more branches current is above the rated value and in subsequent time slots it is lower. This depends on the temperature profile of distribution line cables.

TABLE 2

| | Time | | | |
|---|---|---|---|---|
| Branch | t0-t1 | t1-t2 | t2-t3 | t3-t4 |
| A | | A1: X | A1, A3: 2X | |
| B | B2: X | B3: X | | B4: X |
| C | C2: X | C2: X | | |
| D | D4: X | | D2: X | |
| E | E2, E3: 2Y | E2, E3: 2Y | E2, E3: 2Y | |
| F | F1: Y | F1: Y | F1: Y | F3: Y |
| Overall system | 3X/3Y | 3X/3Y | 3X/3Y | X/Y |

The additional time Δt which may be used depends on the steady state temperature rating and maximum transient temperature rating of the cable. For example if 65 degree Celsius is the normal temperature limit and 100 degrees Celsius is an emergency temperature limit, the time Δt will be the time needed for the cable to reach 100 degree Celsius temperature i.e. 35 degree Celsius temperature rise and Δt1 will be the time to reach again the normal working temperature.

ΔT=(I²−I²_{rated})*R*K*(1−e^{αt})

Where ΔT=Temperature rise in degrees Celsius, I is the current in wire, I_{rated} is the rated current of the cable, R is the resistance of cable, K=Cm/W is thermal coefficient, and α is a time constant.

From the above equation, the additional time Δt can be derived from the characteristics of the cable. There can be rule of thumb based simpler equations also.

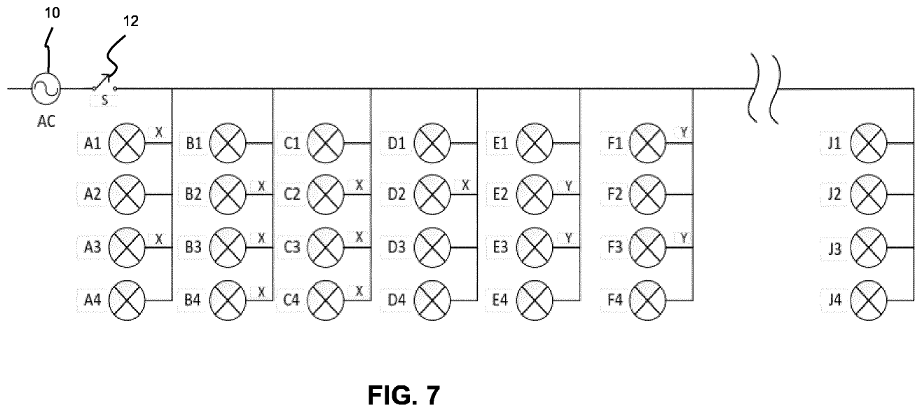

FIG. 7 shows a situation where more luminaires are demanding current (again labeled “X”) than can be handled by the cable capacity. The time division approach of FIG. 5 to reduce the currents to desired levels may be incompatible with achieving the required power transfer across the network to be able to provide backup power for the full duration of the mains isolation.

The controller can then take a decision that the luminaires which are demanding external current (i.e. power) should go into a dimming mode to reduce the current demand. For example, instead of receiving 2 A operational DC current, some luminaire may receive a 1.5 A or 1 A operation DC current while the dimming level is set to 75% or 50% dimming.

In a further embodiment, if it is found that the full duration of the mains isolation is too long, the dimming level of the luminaire that provides the DC current can also be lowered so as to provide more energy to better cover the duration of the mains isolation.

The input or output current to each luminaire may also be changed dynamically based on the state of charge (SoC) of the batteries, the nearby ambient temperature and the current demand of individual luminaires. Thus, the distribution mapping may change dynamically in real time.

To reduce the computational effort at the central controller each luminaire can, based on its SoC, the prevailing luminaire load and the forecasted luminaire load and nearby ambient temperature, decide how much minimum current is needed from the DC grid in different time slots. This will be further helpful whenever communication is broken between the central controller and the luminaires for a brief period. Each individual luminaire node may thus limit its current demand to a minimum based on the demand time and SoC of the associated battery by predicting the worst case scenario in the DC grid distribution line.

The current limits to be applied can be calculated using equations during runtime or can be calculated in advance and pre-stored in tabular form.

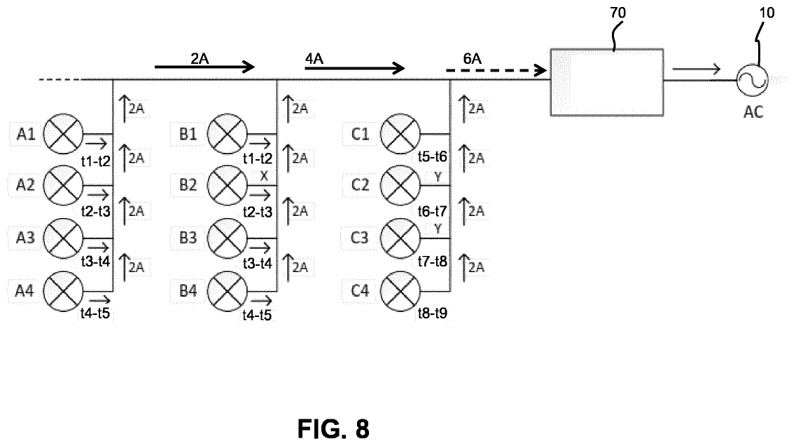

FIG. 8 shows that the lighting network may connect to the AC mains supply 10 via a grid feed inverter. It shows all luminaires (i.e. their local batteries) supplying current in a time division multiplex manner (with timing instants t1 to t5) to the grid.

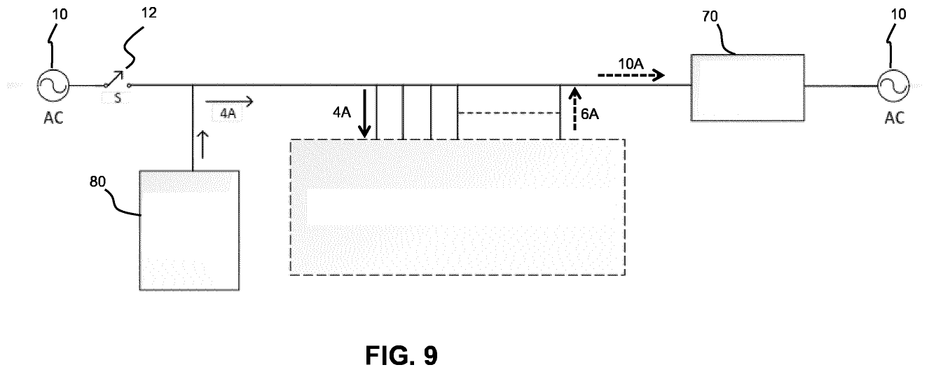

The examples above are based on distributed energy storage. FIG. 9 shows that there may be a centralized battery 80 which connects to the wiring of the power distribution network remotely from the arrangement 82. This may be in addition to or alternative to the local DC power supplies at the luminaires. A centralized battery enables further limiting current in the distribution line for both feeding to the luminaires and to the grid. For example, the center block in FIG. 9 is the luminaires groups A to D as shown in FIG. 5, and they are sharing the 4 A DC current, provided by the centralized battery 80, in a time division manner. In another example for grid feeding, the center bock in FIG. 9 may be the luminaires groups A to C as shown in FIG. 8 that provides a 6 A DC current in a time division manner as shown by the dashed arrow in FIG. 8, and a total current of 10 A then goes to the grid feeding inverter 70 as shown by the dashed arrow in FIG. 9.

The system controller may be adapted to select at least two pairs of a DC power supply and an electrical load, wherein portions of the distribution network that connect the at least two pairs do not overlap and the two pairs exchange the DC current simultaneously such that the DC currents in each pair are essentially isolated. Thus, different parts of a network may be isolated from each other and can conduct a respective DC current simultaneously.

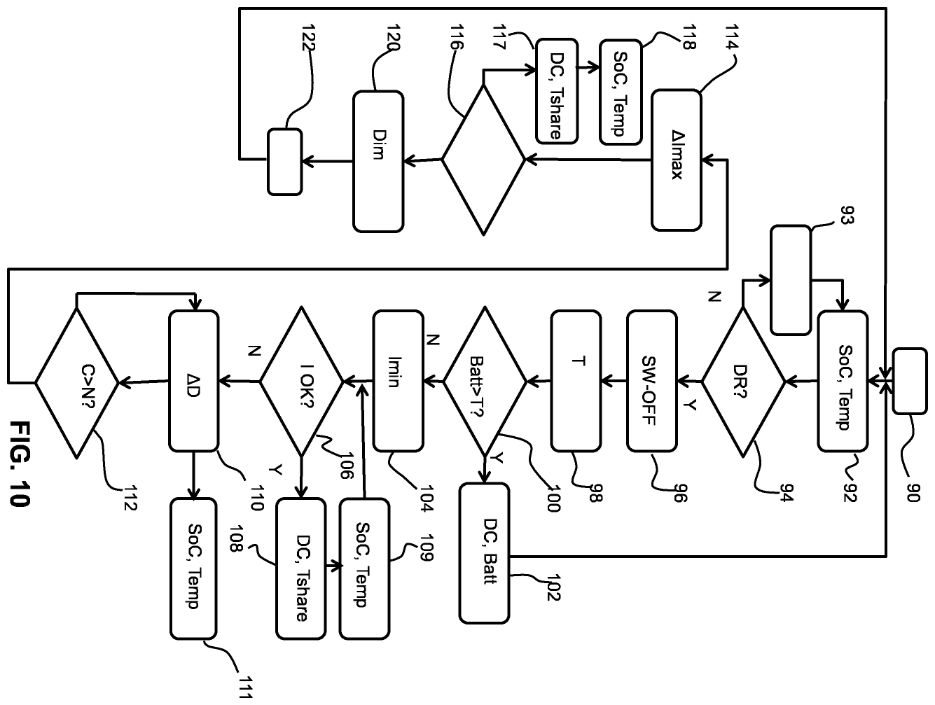

FIG. 10 shows a power distribution method. The method starts at step 90 during which the AC power supply is accessed.

In step 92, the state of charge of the batteries of the individual luminaires, the luminaire loads and the ambient temperature at each luminaire is recorded and provided to the central controller.

In step 94 it is determined if the is a mains failure or a demand request (DR) for disconnection from the mains grid (which may be a request from the utility supplier for load management purposes) or other demand side management (DSM) request for example for load shifting. If there is no such failure or request, the lamps are AC driven in step 93 and the method returns to step 92 to provide continuous update and monitoring.

Thus, during step 93, AC current is conducted from the AC power supply to a plurality of electrical loads, using the distribution network (with its various RMS current ratings).

If there is a mains failure, or a demand side management (DSM) action or a DR request, the mains is isolated using the isolation switch in step 96, and all luminaires are instructed to form a DC grid.

In step 98 the time period T during which mains isolation is required is determined. This may be obtained from the utility supplier (for example in the case of a DR request) or it may be predicted or known in advance.

In step 100 it is determined if the battery SoC is sufficient to meet the luminaire demand during the time period T. If so, in step 102 the load is met by the local battery. Thus, a DC grid mode is enabled but without the need to transfer power around the network. This is thus a default operation, which by design meets the rated current requirements. The method returns to step 92 to continue monitoring.

If the battery cannot meet the demand then in step 104 the luminaires determine the minimum time period Tmin they need the luminaire current 2 A for example from the DC grid and make a request to the central controller. All such requests are mapped at the central controller to the distribution map.

In step 106, it is determined if the total current in each power line in the network can be maintained below the rated current of the network, by making use of time division control as explained above, while still meeting the need to transfer power across the network. If it is, then in step 108 the load is met by DC distribution grid with the time sharing. The SoC, lamp load and ambient temperature is also updated in step 109 and the monitoring in step 106 is repeated.

The DC grid formed is able to meet the demand requirement as well as the current rating requirements.

If there is a current rating problem, a time division multiplexing of current sink and/or current supply to the DC grid is implemented (shown as ΔD in FIG. 10) for the remaining time in step 110, in the above mentioned time-division manner. The changes in current across different distribution sections are made with respect to current rating of particular section cable.

There is then a check whether all constraints including temperature of the distribution line and power availability over the time period T are met given this time division manner. This check can be done by simulation. Alternatively the system can run for a while and the data can be collected for checking. If yes, the SoC, lamp load and ambient temperature are updated in step 111. If not, then a change (shown as ΔD in FIG. 10) in the time division may be carried out as there may be a plurality of possible time divisions, and these changes are to be carried out a set number of times. A count (C) is kept and in step 112 is it determined if a maximum count (N) has been reached.

The process loops back to step 110 to find a new time-division while the threshold number of counts has not been reached. When the count limit has been reached, it is determined that at this DC current level it is not possible to satisfy all constraints, and further measures need to be taken.

The count can be an arbitrary number (such as 10, 100 or 1000) based on the processing speed of central controller and the number of luminaires to arrive at an optimum solution in the optimum time. A time-out counter is used to avoid too much calculation without reaching the acceptable time division. If no proper time division can be found, other countermeasures need to be taken such as allowing the current to exceed the wire rate or even dim down the luminaires.

In step 114, the system can not reach the acceptable time division under the given desired current of the luminaire and the rated current of the network, therefore the system allows the sink/supply current (increasing by ΔImax as shown in FIG. 10) to be above the rated current of the network, up to a certain maximum current rating for a limited period, which has been mentioned above referring to Table 2.

In step 116 it is determined if the current which will flow meet the changed maximum settings. If they do, the altered DC grid formed is able to meet the demand requirement as well as the current rating requirements, by using both a time division approach and temperature profiling. Thus, the DC grid operation is performed in step 117.

The SoC, lamp load and ambient temperature are updated in step 118.

If the temperature profiling does not result in the demand being met, then the central controller instructs the luminaires to perform dimming in step 120 so that the current demand can be altered. The election of luminaires is optimized such that a minimum number of luminaires is affected. In addition, the selection of luminaires is for example spread across a building layout.

The process ends in step 122 where it returns to the start.

The various measures above together ensure that the local DC power supplies supply a time-averaged DC current which is equal to or smaller than the RMS current ratings across the power distribution network.

There is no need for temperature sensors to monitor cable temperatures in different sections. Based on both measured or estimated room temperature and current flowing through different section of distribution lines; a rise in cable temperature for different sections may be estimated by the central controller and the current limits can be optimized.

In addition to current and ambient temperature, the central controller is able to map cable size and insulation information is different sizes and properties of cable are used in different sections.

The current limits for some luminaries may be increased where there is possibility of decrease in ambient or room temperature.

The invention is of particular interest for grid feeding from distributed batteries. Batteries are able to feed power to the grid with a central grid feed invertor in different time slots without voltage conditioning.

The invention is of interest for battery integrated networked luminaires in indoor applications. However, it can be used in outdoor networked battery integrated street lighting system.

The invention is not limited to lighting loads. The same approach may be used for any network of mains powered loads which make use of a DC backup power supply to provide emergency functionality in the event of a mains failure. Examples are safety critical networks of sensors or actuators. A distributed universal power supply may also share battery power in a DC mode.

In summary, the invention makes use of a central controller, for example of a light management system, to map the requirement of energy needs of different luminaires in the network and based on the mapping each luminaire is instructed to control its input or output current (or power) to the grid, ensuring that the current in different sections of the distribution line is within rated limits. Individual luminaire nodes can limit current demand to a minimum based on demand time and the state of charge of a battery associated with it, anticipating the worst-case scenario in the current DC grid distribution line. In an example, batteries are able to feed power to the grid with a central grid feed invertor in different time slots without voltage conditioning. It can also enable centralized batteries to feed power to the gird and its luminaires by limiting the current on DC bus.

The input and output current settings may be changed dynamically and the system may also take account of ambient temperatures.

In another aspect of the invention, it is proposed to add batteries to luminaires used for stadium/stage lighting. These batteries provide power to the luminaires when they required power is higher than the cable ratings. Batteries are charged when luminaire power is lower than cable ratings. Battery is charged through variable power with dynamic charging control with SoC estimation before charging.

Spectacle lighting programs are mostly prepared in advance and tested in simulation as well as in real stadium. In the proposed invention the lighting show data is communicated to luminaires and luminaires autonomously either individually or in group take adequate actions to optimize energy flow to and from batteries to keep the power requirement within limit. Based on the power requirements of luminaires for lighting effects the power flowing in different sections of cable is calculated. If the threshold limits are exceeded, energy flow-out and flow-in the integrated batteries are calculated 60. If the batteries energy flow in and out is not adequate to support the energy requirements of luminaires, the lighting effect program at individual luminaire or at group level may be modified to meet the threshold in such a way that the lighting effects is least impacted. Based on cable layout and system specification central lighting console will update current limitation information data in luminaires at individual level as well as group level. This will be fixed till the layout or infrastructure does not changed. Based on lighting data luminaires will find out that the peak current demand is affecting only the cable connecting it or it is affecting the cable connected to multiple luminaires. In later case anyone can initiate the communication to modify the dimming level at group level.

Optimization of dimming at group level may be possible with multiple options. Each options may result in different color effects such as soft, contrast, colour balance etc. These options are communicated to show manager through central lighting console. Based on selected option the light show will be run. To implement such options the luminaires will modify the lighting data such as in case of SOFT of peak current (above threshold limit) of luminaires are dimmed whereas in case of contrast the lighting data is dimmed from peak to low value.

As discussed above, embodiments make use of a controller. The controller can be implemented in numerous ways, with software and/or hardware, to perform the various functions required. A processor is one example of a controller which employs one or more microprocessors that may be programmed using software (e.g., microcode) to perform the required functions. A controller may however be implemented with or without employing a processor, and also may be implemented as a combination of dedicated hardware to perform some functions and a processor (e.g., one or more programmed microprocessors and associated circuitry) to perform other functions.

Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media such as volatile and non-volatile computer memory such as RAM, PROM, EPROM, and EEPROM. The storage media may be encoded with one or more programs that, when executed on one or more processors and/or controllers, perform the required functions. Various storage media may be fixed within a processor or controller or may be transportable, such that the one or more programs stored thereon can be loaded into a processor or controller.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A power distribution system comprising:
an input for accessing a grid power supply;
a plurality of electrical loads arranged in a plurality of branches or sections;
a distribution network adapted to conduct grid current from said grid power supply to the plurality of electrical loads, wherein said distribution network has an RMS current rating;
a plurality of DC power supplies or a central DC energy storage device for supplying the electrical loads by supplying DC current using the same distribution network to the electrical loads when the grid power supply is unavailable; and
a system controller, which is adapted to control the plurality of DC power supplies to supply a time-averaged DC current which is equal to or smaller than said RMS current rating, wherein said system controller is adapted to consider the state of charge of the DC power supplies and control at least some of the plurality of DC power supplies or the central DC energy storage device to supply at least some of the electrical loads in a time divided manner or in time slots such that the DC current in each branch or section does not exceed the RMS current rating.

2. A system as claimed in claim 1, wherein the grid power supply is AC mains grid power supply, the DC power supplies are associated with each branch or section, and said system controller is adapted to
control a DC power supply in one branch to supply the electrical loads in another branch; and/or
for each of at least two branches, control a DC power supply in one branch to supply the electrical loads in that branch.

3. A system as claimed in claim 1, wherein at least some of said electrical loads are adapted to receive a DC current in a time divided manner for maintaining an instantaneous or average DC current in the distribution network below the RMS current rating.

4. A system as claimed in claim 1, comprising the DC power supplies associated with each of the electrical loads, and wherein the controller is further adapted to:
obtain the length of a duration for which said grid power supply is unavailable;
obtain charging state information for the DC power supply in each of the electrical loads;
determine at least some of the electrical loads which are to supply the DC current from their respective DC power supply and at least some other of the electrical loads which are to receive the DC current; and
configure, accordingly, the DC current to be exchanged between at least some of said plurality of DC power supplies and at least some of the loads.

5. A system as claimed in claim 4, wherein the controller is further adapted to control a drive setting of the electrical loads that are to supply the DC current and/or a drive setting of the electrical loads that are to receive the DC current, thereby to control the power consumption thereof in order to control the DC current.

6. A system as claimed in claim 1, wherein said central DC energy storage device is a battery.

7. A system as claimed in claim 1 further comprising a grid feed inverter adapted to convert the DC current into grid power and feed it to the grid power supply, wherein at least some of said plurality of electrical loads are adapted to supply the DC current to the grid feed inverter in a time divided manner.

8. A system as claimed in claim 1, wherein at least some of said DC power supplies are adapted to supply the DC current simultaneously for a first duration such that the instantaneous DC current on the distribution network is above/exceeds the RMS current rating in the first duration, and the at least some of said DC power supplies are adapted to stop supplying the DC current or supply a DC current below the RMS current rating for a second duration after first duration.

9. A system as claimed in claim 1, wherein the RMS current rating is variable as a function of ambient temperature and the controller is further adapted to determine the RMS current rating based on an ambient temperature.

10. A system as claimed in claim 1, further comprising:
a temperature sensor thermally coupled to the distribution network and adapted to sense a temperature of the distribution network or a temperature estimation unit for estimating the temperature of the distribution network; and
wherein the controller is further adapted to control the DC current according to the temperature of the distribution network.

11. A system as claimed in claim 10 comprising a temperature estimation unit which comprises an ambient temperature sensor and a processor to estimate the temperature of the distribution network according to the instantaneous DC current levels within the distribution network.

12. A lighting system, comprising:
an arrangement of luminaires; and
a power distribution system as claimed in claim 1, wherein each luminaire is an electrical load of the power distribution system, and the system controller comprises a light management system.

13. A power distribution method comprising:
accessing a grid power supply;
when the grid power supply is available:
conducting grid current from said grid power supply to a plurality of electrical loads arranged in a plurality of branches or sections, using a distribution network which has an RMS current rating; and
when the grid power supply is not available:
supplying the electrical loads using a plurality of DC power supplies or a central DC energy storage device to conduct DC current using the same distribution network to the electrical loads, and controlling the plurality of DC power supplies or the central DC energy storage device to supply a time-averaged DC current which is equal to or smaller than said RMS current rating,
wherein considering the state of charge of the DC power supplies and controlling at least some of the plurality of DC power supplies or the central DC energy storage device to supply at least some of the electrical loads in a time divided manner or in time slots such that the DC current in each branch or section does not exceed the RMS current rating.

14. A method as claimed in claim 13, wherein said grid power supply is AC mains grid power supply, and the method further comprising:
controlling a DC power supply in one branch to supply the electrical loads in another branch; and/or
receiving a DC current at the electrical loads in a time divided manner for maintaining an instantaneous or average DC current in the distribution network below the RMS current rating.

15. A computer program comprises compute program code means which is adapted, when said program is run on a computer, to implement the method of claim 13.
